(19) United States
(12) Patent Application Publication
(10) Pub. No.: US 2026/0326381 A1
(43) Pub. Date: Oct. 22, 2026

(54) ADDITIVE MANUFACTURING USING STRESS SIMULATIONS

(71) Applicant: International Business Machines Corporation, Armonk, NY (US)

(72) Inventors: Hamid MAJDABADI, Ottawa (CA); Humberto OROZCO CERVANTES, Tonalá (MX); Sarbajit Kumar RAKSHIT, Kolkata (IN); Carolina GARCIA DELGADO, Zapopan (MX)

(21) Appl. No.: 19/181,765

(22) Filed: Apr. 17, 2025

(51) Int. Cl. B29C 64/386; B33Y 50/00; G06F 30/27; G06F 119/08; G06F 119/14

(52) U.S. Cl. CPC B29C 64/386; G06F 30/27; B33Y 50/00; G06F 2119/08; G06F 2119/14

(57) ABSTRACT

In some implementations, a device may receive one or more indications of a first additive manufacturing object model, one or more additive manufacturing object operational parameters, and one or more additive manufacturing object environmental parameters. The device may perform, based on the one or more additive manufacturing object operational parameters and the one or more additive manufacturing object environmental parameters, a plurality of stress simulations on the first additive manufacturing object model. The device may generate, based on the plurality of stress simulations, a second additive manufacturing object model that includes multiple material types or multiple internal structures.

### BACKGROUND

This disclosure relates to additive manufacturing, and more specifically, to additive manufacturing using stress simulations.

### SUMMARY

Some aspects described herein relate to a computer-implemented method. The computer-implemented method may include receiving, by a device, one or more indications of a first additive manufacturing object model, one or more additive manufacturing object operational parameters, and one or more additive manufacturing object environmental parameters. The computer-implemented method may include performing, by the device, based on the one or more additive manufacturing object operational parameters and the one or more additive manufacturing object environmental parameters, a plurality of stress simulations on the first additive manufacturing object model. The computer-implemented method may include generating, by the device, based on the plurality of stress simulations, a second additive manufacturing object model that includes multiple material types or multiple internal structures.

Some aspects described herein relate to a computer system. The computer system may include a processor set, one or more computer-readable storage media, and program instructions stored on the one or more computer-readable storage media to cause the processor set to perform operations. The operations may include receiving one or more indications of a first additive manufacturing object model, one or more additive manufacturing object operational parameters, and one or more additive manufacturing object environmental parameters. The operations may include performing, based on the one or more additive manufacturing object operational parameters and the one or more additive manufacturing object environmental parameters, a plurality of stress simulations on the first additive manufacturing object model. The operations may include generating, based on the plurality of stress simulations, using a generative adversarial network model, a second additive manufacturing object model that includes multiple material types, or multiple internal structures and one or more transitions between the multiple internal structures.

Some aspects described herein relate to a computer program product. The computer program product may include one or more computer-readable storage media and program instructions stored on the one or more computer-readable storage media to perform operations. The operations may include receiving, one or more indications of a first additive manufacturing object model, one or more additive manufacturing object load parameters, and one or more additive manufacturing object temperature parameters or one or more additive manufacturing object corrosion parameters. The operations may include performing, based on the one or more additive manufacturing object load parameters, and the one or more additive manufacturing object temperature parameters or the one or more additive manufacturing object corrosion parameters, a plurality of stress simulations on the first additive manufacturing object model. The operations may include generating, based on the plurality of stress simulations, a second additive manufacturing object model that includes multiple material types or multiple internal structures.

### BRIEF DESCRIPTION OF THE DRAWINGS

FIG. 1 is a diagram of an example computing environment for additive manufacturing using stress simulations described herein.

FIG. 2 is a diagram of an example associated with additive manufacturing using stress simulations as described herein.

FIG. 3 is a diagram of example components of a device associated with additive manufacturing using stress simulations.

FIG. 4 is a flowchart of an example process associated with additive manufacturing using stress simulations.

### DETAILED DESCRIPTION

The following detailed description of example implementations refers to the accompanying drawings. The same reference numbers in different drawings may identify the same or similar elements.

Additive manufacturing, such as three-dimensional (3D) printing, refers to creation of a 3D object by building the 3D object layer-by-layer. Additive manufacturing has a wide range of applications in various industries, such as architecture, aerospace, automotive, or the like. Large-scale 3D printing refers to creation of 3D objects on a greater scale than traditional 3D printing. In some examples, large-scale 3D printing may involve larger-scale 3D printers that can produce large 3D objects (e.g., object that have dimensions of several feet). Large-scale 3D printing may enable production of precise, durable, and efficient 3D objects having functional, complex, and intricate designs, with fast production times for engineering, manufacturing, or the like. 3D-printed objects can fail due to environmental or operational factors experienced by the 3D-printed objects during use. For example, 3D-printed objects may be damaged due to environmental factors (e.g., corrosion or temperature) and/or operational factors (e.g., load). For example, 3D-printed objects may be designed incorrectly or sub-optimally in view of the environmental or operational factors. As a result, 3D-printed objects may be re-designed, re-manufactured, and/or repaired, which may involve resource-intensive operations. For example, processing resources of the 3D printer may be occupied with executing a 3D printing process, such as controlling movement of one or more nozzles of the 3D printer, extrusion of 3D printing material, or the like. Additionally, or alternatively, 3D printer memory may be occupied due to storing design files, instructions for 3D printing the 3D objects, or the like.

Some implementations described herein enable designing and manufacturing a 3D-printed object based on operational and environmental parameters using stress simulations. In some aspects, the stress simulations may model how a 3D-printed object behaves under conditions defined by the operational and environmental parameters (e.g., under defined loads on specific locations of the 3D-printed object, corrosive conditions, temperatures, or the like). The stress simulations may be performed iteratively, such that each stress simulation modifies one or more design parameters of the 3D-printed object. For example, the stress simulations may test different materials and internal structures of the 3D-printed object under the conditions defined by the operational and environmental parameters. Based on the simulated performance of the material types and internal structures, a 3D-printed object model may be generated that includes multiple material types and/or internal structures. For example, a high-stress portion of the 3D-printed object may be assigned a high-resilience material type and/or internal structure, and a low-stress portion of the 3D-printed object may be assigned a lower-resilience material type and/or internal structure. In some aspects, the 3D-printed object model may be designed such that the high-stress portions are replaceable (e.g., modular) and/or self-healing.

As a result, a performance and longevity of the resulting 3D-printed object may be increased. For example, the stress simulations may help to identify potential vulnerabilities and generate a redesigned 3D-printed object model that includes multiple material types or internal structures tailored to withstand expected environmental and operational conditions. As a result, resource-intensive re-design, re-manufacturing, and repair operations may be reduced. For example, processing resources that would otherwise be occupied with executing 3D printing processes due to 3D-printed object failures may be re-allocated for other tasks. Additionally, or alternatively, memory resources that would otherwise be occupied with storing design files and/or instructions for 3D printing due to 3D-printed object failures may be re-allocated for other tasks.

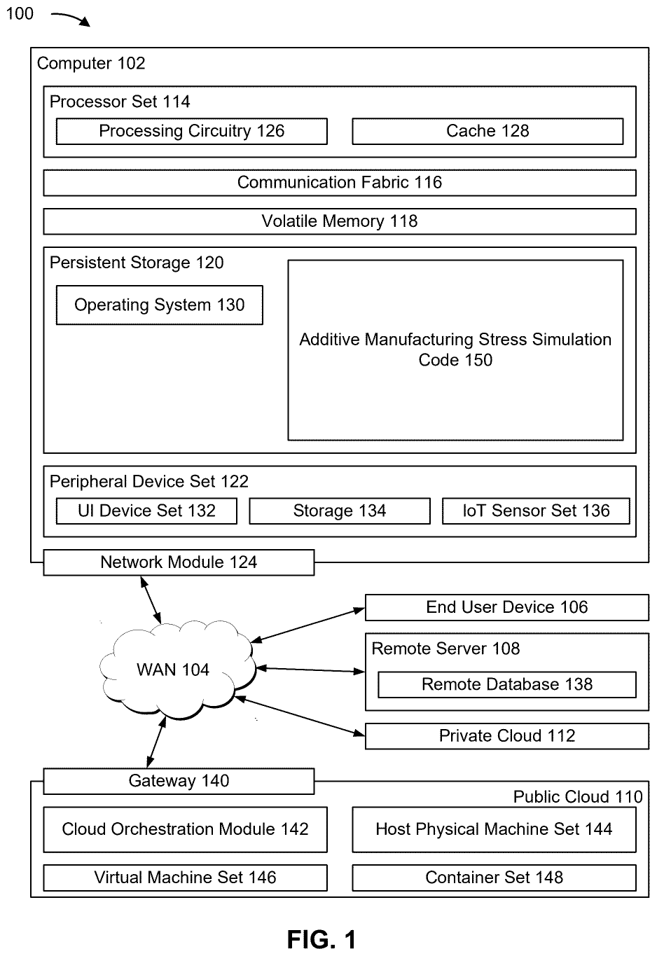

FIG. 1 is a diagram of an example computing environment 100 for additive manufacturing using stress simulations described herein.

The computing environment 100 contains an example of an environment for the execution of at least some of the computer code involved in performing the inventive methods, such as additive manufacturing stress simulation code 150. In addition to the additive manufacturing stress simulation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the additive manufacturing stress simulation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in additive manufacturing stress simulation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the additive manufacturing stress simulation code 150 typically includes at least some of the computer code involved in performing one or more operations described herein. In some implementations, the operations may include receive one or more indications of a first additive manufacturing object model, one or more additive manufacturing object operational parameters, and one or more additive manufacturing object environmental parameters; perform, based on the one or more additive manufacturing object operational parameters and the one or more additive manufacturing object environmental parameters, a plurality of stress simulations on the first additive manufacturing object model; and generate, based on the plurality of stress simulations, a second additive manufacturing object model that includes multiple material types or multiple internal structures.

In some implementations, the operations may include receiving one or more indications of a first additive manufacturing object model, one or more additive manufacturing object operational parameters, and one or more additive manufacturing object environmental parameters; performing, based on the one or more additive manufacturing object operational parameters and the one or more additive manufacturing object environmental parameters, a plurality of stress simulations on the first additive manufacturing object model; and generating, based on the plurality of stress simulations, using a generative adversarial network model, a second additive manufacturing object model that includes multiple material types, or multiple internal structures and one or more transitions between the multiple internal structures.

In some implementations, the operations may include receiving one or more indications of a first additive manufacturing object model, one or more additive manufacturing object load parameters, and one or more additive manufacturing object temperature parameters or one or more additive manufacturing object corrosion parameters; performing, based on the one or more additive manufacturing object load parameters, and the one or more additive manufacturing object temperature parameters or the one or more additive manufacturing object corrosion parameters, a plurality of stress simulations on the first additive manufacturing object model; and generating, based on the plurality of stress simulations, a second additive manufacturing object model that includes multiple material types or multiple internal structures.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

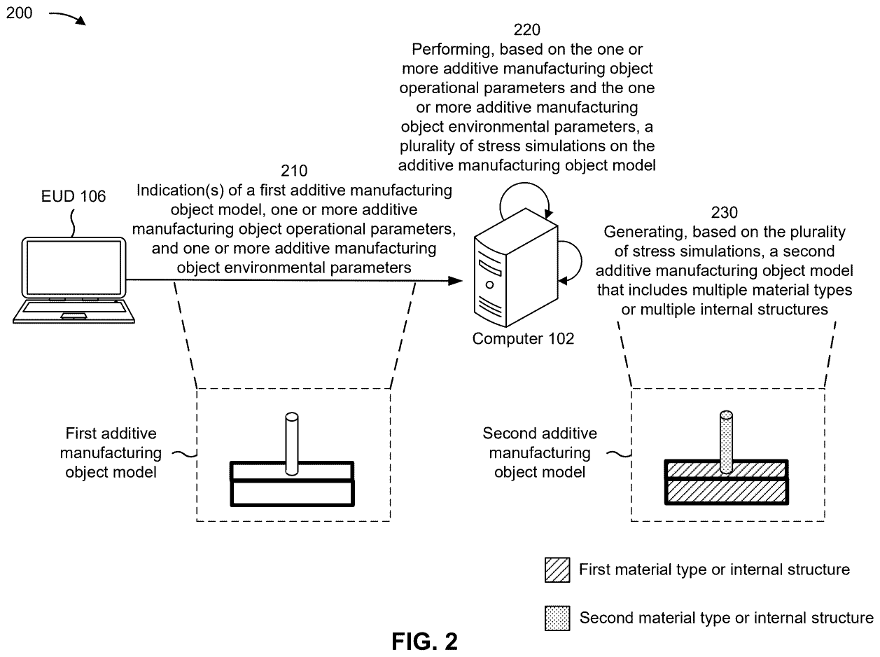

FIG. 2 is a diagram of an example 200 associated with additive manufacturing using stress simulations as described herein. Example 200 shows the EUD 106 and the computer 102. In some examples, the computer 102 may be communicatively coupled to an additive manufacturing system (e.g., a 3D printer). For example, the computer 102 may communicate with the additive manufacturing system over wired and/or wireless communication links using the communication fabric 116, the network module 124, or the like. The computer 102 may control various aspects of the operation of the additive manufacturing system, such as additive manufacturing of an object. In some examples, the computer 102 may be a part of the additive manufacturing system, and may correspond to the control system of the additive manufacturing system (e.g., the computer 102 may be embedded in the form factor of the additive manufacturing system). In some examples, the computer 102 may be located remote from the additive manufacturing system.

As shown by reference number 210, the EUD 106 may transmit, and the computer 102 may receive, one or more indications of a first additive manufacturing object model, one or more additive manufacturing object operational parameters, and one or more additive manufacturing object environmental parameters. An additive manufacturing object model may be a digital representation of an additive manufacturing object (e.g., a 3D object, such as a machine part). For example, an additive manufacturing object model may be a digital file that contains information about a geometry (e.g., dimensions, shape, size, or the like) of the additive manufacturing object. In some examples, the additive manufacturing object may be a large-scale additive manufacturing object (e.g., have dimensions of several feet) that is to be additively manufactured (e.g., 3D printed). In some examples, the first additive manufacturing object model may be an initial version of a 3D model of the additive manufacturing object. The one or more additive manufacturing object operational parameters may indicate a target use of the additive manufacturing object. The one or more additive manufacturing object environmental parameters may indicate one or more conditions of a target environment of the additive manufacturing object. In example 200, the computer 102 receives the indication of the one or more additive manufacturing object geometric parameters and the one or more additive manufacturing object variable stiffness parameters from the EUD 106; in other examples, the computer 102 may receive the additive manufacturing object geometric parameter(s) and additive manufacturing object variable stiffness parameter(s) from a device or component that is different from the EUD 106, such as the remote server 108, the public cloud 110, the private cloud 112, the UI device set 132, or the like.

In some aspects, the one or more additive manufacturing object operational parameters may include one or more additive manufacturing object load parameters. The one or more additive manufacturing object load parameters may indicate a characteristic of a target load of the additive manufacturing object. For example, the one or more additive manufacturing object load parameters may include a payload (e.g., a weight, or a range of weights, to be supported by the additive manufacturing object), a type of load, a direction of the load, a frequency of the load (e.g., vibrations), an indication of whether the load is static or dynamic, or the like.

In some aspects, the one or more additive manufacturing object environmental parameters may include one or more additive manufacturing object temperature parameters or one or more additive manufacturing object corrosion parameters. The one or more additive manufacturing object temperature parameters may indicate a temperature, a range of temperatures (e.g., temperature variations, such as in the case of thermal cycling) of the target environment of the additive manufacturing object. The one or more additive manufacturing object corrosion parameters may indicate corrosive conditions or factors of the target environment of the additive manufacturing object. For example, the one or more additive manufacturing object corrosion parameters may indicate an expected exposure of the additive manufacturing object to the corrosive conditions (e.g., an expected wear of the additive manufacturing object).

As shown by reference number 220, the computer 102 may perform, based on the one or more additive manufacturing object operational parameters and the one or more additive manufacturing object environmental parameters, a plurality of stress simulations on the first additive manufacturing object model. The stress simulations may be a set of computational analyses that model the behavior of the additive manufacturing object under various operational and environmental conditions. For example, the stress simulations may model the behavior of the additive manufacturing object under operational conditions (e.g., target loads) indicated by the one or more additive manufacturing object operational parameters, or under environmental conditions (e.g., temperature or corrosion conditions) indicated by the one or more additive manufacturing object environmental parameters. In some examples, the computer 102 may define boundary conditions, such as maximum or minimum values for the one or more additive manufacturing object operational parameters or for the one or more additive manufacturing object environmental parameters (e.g., a maximum or minimum support, force, moment, or the like). In some examples, the computer 102 may convert the first additive manufacturing object model into a finite element mesh model and perform the stress simulations on the finite element mesh model. For example, the computer 102 may assign an appropriate mesh density to the finite element mesh model (e.g., the finite element mesh model may have a high mesh density in regions of the additive manufacturing object having high stress gradients or where material property changes are expected).

In some examples, the stress simulations may be iterative. For example, the computer 102 may perform a first stress simulation under a first set of conditions, change one or more values of the first set of conditions, perform a second stress simulation under the second set of conditions, and so forth. For example, the computer 102 may perform an initial stress simulation that evaluates a stress distribution or deformation of the additive manufacturing model under a set of initial conditions. The computer 102 may use an output of the initial stress simulation as one or more reference data points indicating a behavior of the additive manufacturing model under the initial set of conditions, and may perform a subsequent stress simulation under a different set of conditions based on the output of the initial stress simulation. For example, the computer 102 may modify conditions of a stress simulation that yielded a most recent high-performing result, and determine whether a result of a stress simulation with the modified conditions further improves that result. The conditions may be based on the additive manufacturing object operational parameters or the additive manufacturing object environmental parameters. For example, the conditions may include load conditions (such as tensile, bending, or twisting forces), vibration, thermal expansion, impact, fatigue cycles, cyclic loads, candidate materials of the additive manufacturing object, candidate internal structures of the additive manufacturing object, stress propagation, and/or different combinations thereof. In some examples, the stress simulations may model additive manufacturing objects having modified geometric properties compared to first additive manufacturing object model.

In some examples, the computer 102 may store, or have access to, a repository (e.g., a database) of the candidate materials and associated properties, such as strength (e.g., fatigue strength) properties, melting point properties, density or weight properties, cost properties, thermal properties, or the like. The candidate materials may include composite materials, graded materials, metamaterials, or the like. Additionally, or alternatively, the computer 102 may store, or have access to, a repository (e.g., a database) of the candidate internal structures (e.g., ranging from solid internal structure to various mesh structures) and associated properties, such as minimum quantities of the candidate materials to manufacture the additive manufacturing object, and manufacturing times (e.g., minimum times to manufacture the additive manufacturing object having the candidate internal structures), manufacturing cost, strength properties, crack propagation properties, density or weight properties, or the like. The repository may include single structures and/or composite structures. For example, the stress simulations may model the additive manufacturing object with different mesh internal structures, solid internal structures, and/or combinations of types of internal structures. Each stress simulation may output a maximum stress or strength that can be supported by, or a deformation of, the additive manufacturing object (or on one or more portions thereof) based on the one or more additive manufacturing object operational parameters and the one or more additive manufacturing object environmental parameters.

In some examples, the stress simulations may model stresses experienced by various portions of the additive manufacturing object that have respective candidate materials and/or respective candidate internal structures. In some examples, the computer 102 may simulate and evaluate different operational parameters (e.g., loads, such as stresses or forces) on various portions of the additive manufacturing object. For example, the computer 102 may use finite element analysis and/or stress-strain data generated from the stress simulations to identify stress concentration areas of the additive manufacturing object. Stress concentration areas may include portions of the additive manufacturing object that experience higher-than-average stress. For example, the stress concentration areas may be vulnerable zones or regions that are prone to fatigue, yielding, damage, cracking, chipping, or excessive wear over time, and, therefore, may experience a failure mode.

Thus, the stress simulations may help the computer 102 to identify the forces that are applied on different portions of the additive manufacturing object. For example, the computer 102 may use the stress simulations to identify (e.g., segment the additive manufacturing object into) high-stress portions of the additive manufacturing object, moderate-stress portions of the additive manufacturing object, and/or low-stress portions of the additive manufacturing object, where the high-stress portions (e.g., critical load points) are more susceptible to internal or external damage than the moderate-stress portions, and the moderate-stress portions are more susceptible to internal or external damage than the low-stress portions. Additionally, or alternatively, the computer 102 may identify the types of damage that may occur in these portions. In some examples, the computer 102 may, based on identifying the high-stress portions, moderate-stress portions, and low-stress portions, select the materials and/or internal structures for subsequent stress simulations. Additionally, or alternatively, the computer 102 may, based on identifying the high-stress portions, moderate-stress portions, and low-stress portions, assign the materials and/or internal structures to respective portions of the additive manufacturing object. For example, a first material and/or internal structure may correspond to a high-stress portion, and a second material and/or internal structure may correspond to a low-stress portion.

As shown by reference number 230, the computer 102 may generate, based on the plurality of stress simulations, a second additive manufacturing object model that includes multiple material types or multiple internal structures. In some examples, the computer 102 may determine, based on the outputs of the stress simulations (e.g., identified failure points of the additive manufacturing object under certain conditions), that the additive manufacturing object is to include the multiple material types or multiple internal structures. For example, portions of the additive manufacturing object may include respective types of materials (e.g., composite materials, graded materials, metamaterials, or the like) and/or respective types of internal structures (e.g., solid structures and/or different types of mesh structures). The computer 102 may select the multiple material types or multiple internal structures based on one or more properties that the multiple material types or multiple internal structures would provide to the additive manufacturing object (or different portions thereof) under the one or more additive manufacturing object operational parameters and the one or more additive manufacturing object environmental parameters. For example, the computer 102 may assign the multiple internal structures to respective portions of the additive manufacturing object based on load-bearing requirements, operational stress, and/or other functional considerations. In some examples, the computer 102 may select the multiple material types or multiple internal structures that satisfies an optimization rule that controls how the one or more properties are prioritized (e.g., the optimization rule may indicate how the computer 102 is to correlate various environments and/or operational properties of an additive manufacturing object model). In some examples, the computer 102 may select the multiple material types or multiple internal structures based on the properties of the multiple material types or multiple internal structures stored in one or more repositories. In some examples, the second additive manufacturing object model may be adapted from the first additive manufacturing object model. For example, the second additive manufacturing object model may be a modified version of the first additive manufacturing object model that incorporates the multiple material types or multiple internal structures (and/or altered geometric properties). In some examples, an additive manufacturing system (e.g., a 3D printer) may print the additive manufacturing object with the multiple material types or multiple internal structures in accordance with the iterative simulations.

In some aspects, the computer 102 may generate the second additive manufacturing object model using a generative adversarial network (GAN) model. A GAN is a machine learning framework in which the GAN model (e.g., a generator) is trained to produce data based on output from a discriminator that attempts to distinguish generator-produced data from real data. For example, the GAN model may learn how to create smooth transitions between adjacent sections of the second additive manufacturing object model having different internal structures. During a deployment phase of the GAN model, the computer 102 may input, to the GAN model, one or more results from the stress simulations (e.g., one or more simulated performances of the additive manufacturing object under simulated stress), the multiple material types, the multiple internal structures, the first additive manufacturing object model, a preliminary version of the second additive manufacturing object model (e.g., a version that contains the multiple material types or multiple internal structures without the smooth transitions), and/or the like. Additionally, or alternatively, the computer 102 may receive, as output from the GAN model, the second additive manufacturing object model (e.g., with the smooth transitions). For example, a first section may have a high-density mesh, and a second section could be more porous, or solid; in this example, the GAN model may modify a preliminary version of the second additive manufacturing object model (and/or generate the second additive manufacturing object model) with smooth transitions between the first and second sections. In some examples, the GAN model may introduce the smooth transitions using a loss function that minimizes sudden changes in geometry or density, thereby avoiding sharp curvature or sudden changes in internal structures between adjacent sections. In some examples, the internal structures may remain in each section, thereby preserving targeted additive manufacturing object properties (e.g., structural integrity, stress distribution, stiffness, durability or the like).

In some aspects, the second additive manufacturing object model may include one or more self-healing materials in one or more sections of the second additive manufacturing object model in accordance with one or more predicted stress levels associated with one or more sections. A self-healing material has the ability to automatically repair the self-healing material after being damaged. In some examples, the computer 102 may identify the one or more sections as being vulnerable to internal or external damage (e.g., stress or fatigue), a type of the damage, a size of the damage, a location of the damage (e.g., an area of the second additive manufacturing object model projected to have high activity), or the like. For example, the one or more sections may be high-stress portions of the second additive manufacturing object model. Thus, one or more of the multiple material types may be self-healing materials that activate in response to damage and autonomously repair the damage in the one or more sections. For example, the additive manufacturing system (e.g., the 3D printer) may integrate self-healing materials into the additive manufacturing object.

In some aspects, the second additive manufacturing object model may include one or more modular components in one or more sections of the second additive manufacturing object model in accordance with one or more predicted stress levels associated with one or more sections. A modular component is an interchangeable part that can be replaced (e.g., removed or added) without impacting other components of the additive manufacturing object. In some examples, the computer 102 may identify the one or more sections as being vulnerable to internal or external damage (e.g., stress or fatigue), a type of the damage, a size of the damage, a location of the damage (e.g., an area of the second additive manufacturing object model projected to have high activity), or the like. For example, the one or more sections may be high-stress portions of the second additive manufacturing object model. Thus, the one or more sections may be modular components that can be replaced in response to damage. For example, the additive manufacturing system (e.g., the 3D printer) may integrate modular components into the additive manufacturing object. In some examples, the GAN model may generate one or more designs of the modular component(s). Additionally, or alternatively, the GAN model may generate instructions for assembly or replacement of the modular component(s).

In some aspects, the computer 102 may generate the second additive manufacturing object model based on one or more predicted lifespans associated with the multiple material types. A predicted lifespan (e.g., a predicted fatigue life) is an expected length of time until damage reduces or eliminates a functionality of a part (e.g., the additive manufacturing object or a component thereof). A predicted lifespan may be associated with a material type in that the predicted lifespan may be an expected length of time until damage reduces or eliminates a functionality of the material type. For example, the one or more predicted lifespans (and/or other lifecycle analytics) may be indicated by the stress simulations. In some examples, the computer 102 may adjust a design of the first additive manufacturing object model to produce the second additive manufacturing object model based on the one or more predicted lifespans. For example, the computer 102 may select material types or internal structures that improve the lifespan of the additive manufacturing object.

In some aspects, the computer 102 may generate the second additive manufacturing object model based on based on one or more of a weight associated with the second additive manufacturing object model, a strength associated with the second additive manufacturing object model, a manufacturing time associated with the second additive manufacturing object model, or a deformation associated with the second additive manufacturing object model. For example, the computer 102 may evaluate, based on the stress simulations, how different portions of the additive manufacturing object having the multiple material types or multiple internal structures would impact one or more properties of the additive manufacturing object. The properties may include the weight (e.g., a self-weight), the strength (e.g., a maximum strength or load that can be supported by the additive manufacturing object), the manufacturing time (e.g., a productivity associated with the additive manufacturing object, such as a minimum time required to create the additive manufacturing object), or the deformation (e.g., an expected deformation exhibited by the additive manufacturing object). For example, the computer 102 may select multiple material types or multiple internal structures that reduce the weight, increase the strength, provide structural integrity under tensile, bending, and twisting forces, or a combination thereof. Additionally, or alternatively, the properties may include a material cost associated with the second additive manufacturing object model (e.g., a cost to create the additive manufacturing object), or the like.

Generating the second additive manufacturing object model that includes multiple material types or multiple internal structures based on the plurality of stress simulations may help to increase a performance and longevity of the additive manufacturing object. For example, the stress simulations may help to identify potential vulnerabilities in the first additive manufacturing object model, and these vulnerabilities may be address with the multiple material types or multiple internal structures, which may help the additive manufacturing object to withstand expected environmental and operational conditions as indicated by the one or more additive manufacturing object operational parameters and the one or more additive manufacturing object environmental parameters. As a result, resource-intensive re-design, re-manufacturing, and repair operations may be reduced. For example, processing resources that would otherwise be occupied with executing additive manufacturing processes due to additive manufacturing object failures may be re-allocated for other tasks. Additionally, or alternatively, memory resources that would otherwise occupied with storing design files and/or instructions for additive manufacturing object processes due to additive manufacturing object failures may be re-allocated for other tasks.

The second additive manufacturing object model including the one or more self-healing materials may help to further reduce consumption of processing or memory resources of the additive manufacturing system. For example, the self-healing material may help to reduce a quantity of re-design, re-manufacturing, and/or repair operations that would otherwise be employed to fix the one or more sections and/or the entire additive manufacturing object.

The second additive manufacturing object model including the one or more modular components may help to further reduce consumption of processing or memory resources of the additive manufacturing system. For example, the modular components may help to reduce a quantity of re-design, re-manufacturing, and/or repair operations that would otherwise be employed to fix the entire additive manufacturing object.

FIG. 2 is provided as an example. Other examples may differ from what is described with regard to FIG. 2.

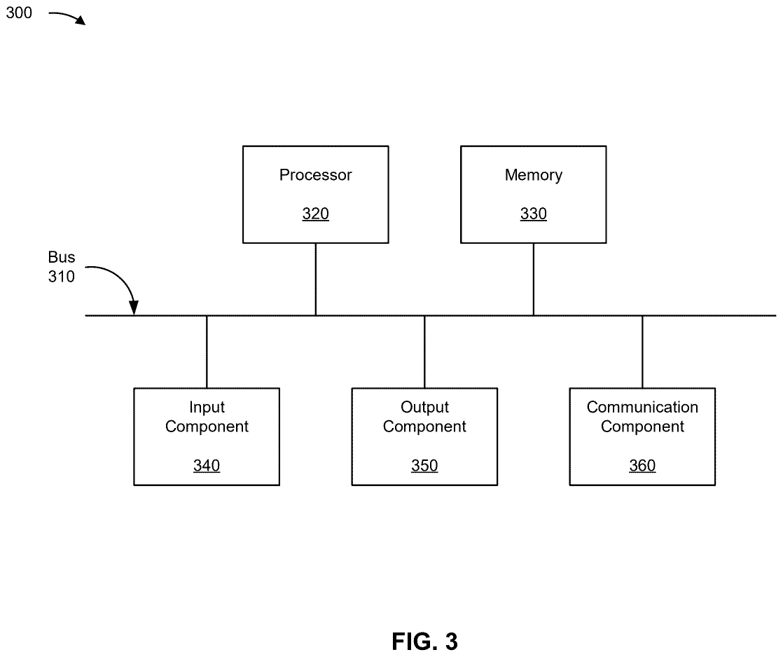

FIG. 3 is a diagram of example components of a device 300 associated with additive manufacturing using stress simulations. The device 300 corresponds to one or more of the computer 102, EUD 106, the remote server 108, the public cloud 110, and/or the private cloud 112. In some implementations, the computer 102, EUD 106, the remote server 108, the public cloud 110, and/or the private cloud 112 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

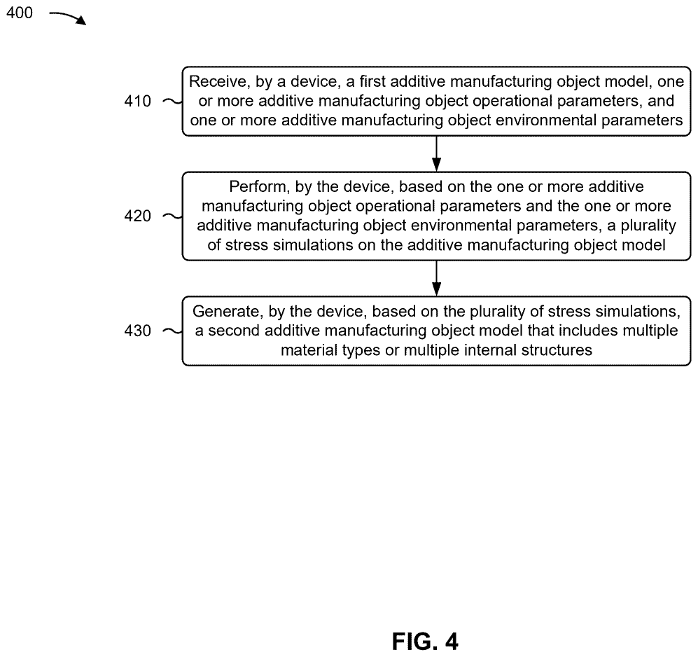

FIG. 4 is a flowchart of an example process 400 associated with additive manufacturing using stress simulations. One or more process blocks of FIG. 4 are performed by a device (e.g., computer 102) and/or by another device or a group of devices separate from or including the device, such as a EUD (e.g., EUD 106), a remote server (e.g., remote server 108), a public cloud (e.g., public cloud 110) and/or a private cloud (e.g., private cloud 112). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving one or more indications of a first additive manufacturing object model, one or more additive manufacturing object operational parameters, and one or more additive manufacturing object environmental parameters (block 410). For example, the device may receive one or more indications of a first additive manufacturing object model, one or more additive manufacturing object operational parameters, and one or more additive manufacturing object environmental parameters, as described above.

As further shown in FIG. 4, process 400 includes performing, based on the one or more additive manufacturing object operational parameters and the one or more additive manufacturing object environmental parameters, a plurality of stress simulations on the first additive manufacturing object model (block 420). For example, the device may perform, based on the one or more additive manufacturing object operational parameters and the one or more additive manufacturing object environmental parameters, a plurality of stress simulations on the first additive manufacturing object model, as described above.

As further shown in FIG. 4, process 400 includes generating, based on the plurality of stress simulations, a second additive manufacturing object model that includes multiple material types or multiple internal structures (block 430). For example, the device may generate, based on the plurality of stress simulations, a second additive manufacturing object model that includes multiple material types or multiple internal structures, as described above.

Process 400 may include additional aspects, such as any single aspect or any combination of aspects described below and/or in connection with one or more other processes described elsewhere herein.

In a first aspect, the one or more additive manufacturing object operational parameters include one or more additive manufacturing object load parameters.

In a second aspect, alone or in combination with the first aspect, the one or more additive manufacturing object environmental parameters include one or more additive manufacturing object temperature parameters or one or more additive manufacturing object corrosion parameters.

In a third aspect, alone or in combination with one or more of the first and second aspects, the second additive manufacturing object model includes one or more transitions between the multiple internal structures, and generating the second additive manufacturing object model comprises generating the second additive manufacturing object model using a generative adversarial network model.

In a fourth aspect, alone or in combination with one or more of the first through third aspects, the second additive manufacturing object model includes one or more self-healing materials in one or more sections of the second additive manufacturing object model in accordance with one or more predicted stress levels associated with one or more sections.

In a fifth aspect, alone or in combination with one or more of the first through fourth aspects, the second additive manufacturing object model includes one or more modular components in one or more sections of the second additive manufacturing object model in accordance with one or more predicted stress levels associated with one or more sections.

In a sixth aspect, alone or in combination with one or more of the first through fifth aspects, generating the second additive manufacturing object model comprises generating the second additive manufacturing object model based on one or more predicted lifespans associated with the multiple material types.

In a seventh aspect, alone or in combination with one or more of the first through sixth aspects, generating the second additive manufacturing object model comprises generating the second additive manufacturing object model based on one or more of a weight associated with the second additive manufacturing object model, a strength associated with the second additive manufacturing object model, a manufacturing time associated with the second additive manufacturing object model, or a deformation associated with the second additive manufacturing object model.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
receiving, by a device, one or more indications of a first additive manufacturing object model, one or more additive manufacturing object operational parameters, and one or more additive manufacturing object environmental parameters;
performing, by the device, based on the one or more additive manufacturing object operational parameters and the one or more additive manufacturing object environmental parameters, a plurality of stress simulations on the first additive manufacturing object model; and
generating, by the device, based on the plurality of stress simulations, a second additive manufacturing object model that includes multiple material types or multiple internal structures.

2. The computer-implemented method of claim 1, wherein the one or more additive manufacturing object operational parameters include one or more additive manufacturing object load parameters.

3. The computer-implemented method of claim 1, wherein the one or more additive manufacturing object environmental parameters include one or more additive manufacturing object temperature parameters or one or more additive manufacturing object corrosion parameters.

4. The computer-implemented method of claim 1, wherein the second additive manufacturing object model includes one or more transitions between the multiple internal structures, and generating the second additive manufacturing object model comprises:
generating the second additive manufacturing object model using a generative adversarial network model.

5. The computer-implemented method of claim 1, wherein the second additive manufacturing object model includes one or more self-healing materials in one or more sections of the second additive manufacturing object model in accordance with one or more predicted stress levels associated with one or more sections.

6. The computer-implemented method of claim 1, wherein the second additive manufacturing object model includes one or more modular components in one or more sections of the second additive manufacturing object model in accordance with one or more predicted stress levels associated with one or more sections.

7. The computer-implemented method of claim 1, wherein generating the second additive manufacturing object model comprises:
generating the second additive manufacturing object model based on one or more predicted lifespans associated with the multiple material types.

8. The computer-implemented method of claim 1, wherein generating the second additive manufacturing object model comprises:
generating the second additive manufacturing object model based on one or more of a weight associated with the second additive manufacturing object model, a strength associated with the second additive manufacturing object model, a manufacturing time associated with the second additive manufacturing object model, or a deformation associated with the second additive manufacturing object model.

9. A computer system comprising:
a processor set;
one or more computer-readable storage media; and
program instructions stored on the one or more computer-readable storage media to cause the processor set to perform operations comprising:
receiving one or more indications of a first additive manufacturing object model, one or more additive manufacturing object operational parameters, and one or more additive manufacturing object environmental parameters;
performing, based on the one or more additive manufacturing object operational parameters and the one or more additive manufacturing object environmental parameters, a plurality of stress simulations on the first additive manufacturing object model; and
generating, based on the plurality of stress simulations, using a generative adversarial network model, a second additive manufacturing object model that includes multiple material types, or multiple internal structures and one or more transitions between the multiple internal structures.

10. The computer system of claim 9, wherein the one or more additive manufacturing object operational parameters include one or more additive manufacturing object load parameters.

11. The computer system of claim 9, wherein the one or more additive manufacturing object environmental parameters include one or more additive manufacturing object temperature parameters or one or more additive manufacturing object corrosion parameters.

12. The computer system of claim 9, wherein the second additive manufacturing object model includes one or more self-healing materials in one or more sections of the second additive manufacturing object model in accordance with one or more predicted stress levels associated with one or more sections.

13. The computer system of claim 9, wherein the second additive manufacturing object model includes one or more modular components in one or more sections of the second additive manufacturing object model in accordance with one or more predicted stress levels associated with one or more sections.

14. The computer system of claim 9, wherein generating the second additive manufacturing object model comprises:
generating the second additive manufacturing object model based on one or more predicted lifespans associated with the multiple material types.

15. A computer program product comprising:
one or more computer-readable storage media; and
program instructions stored on the one or more computer-readable storage media to perform operations comprising:
receiving one or more indications of a first additive manufacturing object model, one or more additive manufacturing object load parameters, and one or more additive manufacturing object temperature parameters or one or more additive manufacturing object corrosion parameters;
performing, based on the one or more additive manufacturing object load parameters, and the one or more additive manufacturing object temperature parameters or the one or more additive manufacturing object corrosion parameters, a plurality of stress simulations on the first additive manufacturing object model; and
generating, based on the plurality of stress simulations, a second additive manufacturing object model that includes multiple material types or multiple internal structures.

16. The computer program product of claim 15, wherein the second additive manufacturing object model includes one or more transitions between the multiple internal structures, and generating the second additive manufacturing object model comprises:
generating the second additive manufacturing object model using a generative adversarial network model.

17. The computer program product of claim 15, wherein the second additive manufacturing object model includes one or more self-healing materials in one or more sections of the second additive manufacturing object model in accordance with one or more predicted stress levels associated with one or more sections.

18. The computer program product of claim 15, wherein the second additive manufacturing object model includes one or more modular components in one or more sections of the second additive manufacturing object model in accordance with one or more predicted stress levels associated with one or more sections.

19. The computer program product of claim 15, wherein generating the second additive manufacturing object model comprises:
generating the second additive manufacturing object model based on one or more predicted lifespans associated with the multiple material types.

20. The computer program product of claim 15, wherein generating the second additive manufacturing object model comprises:
generating the second additive manufacturing object model based on one or more of a weight associated with the second additive manufacturing object model, a strength associated with the second additive manufacturing object model, a manufacturing time associated with the second additive manufacturing object model, or a deformation associated with the second additive manufacturing object model.
